(19) United States
(12) Patent Application Publication
(10) Pub. No.: US 2005/0050273 A1
(43) Pub. Date: Mar. 3, 2005

(54) RAID controller architecture with integrated map-and-forward function, virtualization, scalability, and mirror consistency

(76) Inventors: Robert L. Horn, Yorba Linda, CA (US); Virgil V. Wilkins, Perris, CA (US)

Correspondence Address: DICKSTEIN SHAPIRO MORIN & OSHINSKY LLP, 2101 L Street, NW, Washington, DC, 20037, US

(21) Appl. No.: 10/822,793

(22) Filed: Apr. 13, 2004

Related U.S. Application Data
(60) Provisional application No. 60/497,918, filed on Aug. 27, 2003.

(51) Int. Cl. G06F 12/08

(52) U.S. Cl. 711/114; 711/150; 711/203

(57) ABSTRACT

A RAID controller with decentralized transaction processor controllers and a decentralized cache allows for unlimited scalability in a networked storage system. Virtualization is provided through a map-and-forward function in which a virtual volume is mapped to its logical volumes at the controller level. Any controller in the system can map a request from any host port to any logical storage element. The network storage system provides a controller/virtualizer architecture for providing mirror consistency in a virtual storage environment in which different hosts may read or write to the same logical block address simultaneously. Each storage controller or virtualization engine controls access to a specific set of storage elements. One virtualizer engine is the coordinator, and monitors all write requests and looks for potential data conflicts. The coordinator alleviates conflicts by holding specific requests in a queue until execution of those request causes no data inconsistencies or cache incoherencies.

### CROSS-REFERENCES TO RELATED APPLICATIONS

This application claims the benefit of U.S. Provisional Application Ser. No. 60/497,918, filed Aug. 27, 2003, and is related to U.S. application Ser. No. 09/716,195, filed Nov. 17, 2000, entitled, “Integrated I/O Controller” and U.S. application Ser. No. 10/429,048, filed May 5, 2003, entitled “System and Method for Scalable Transaction Processing,” the entire disclosures of which are incorporated herein by reference.

### FIELD OF INVENTION

The present invention relates to networked storage systems.

### BACKGROUND OF THE INVENTION

With the accelerating growth of Internet and intranet communication, high-bandwidth applications (such as streaming video), and large information databases, the need for networked storage systems has increased dramatically.

In networked storage systems, users access the data on the storage elements through host ports. The host ports may be located in close proximity to the storage elements or they may be several miles away. The storage elements used in networked storage systems are often hard disk drives. Unfortunately, when a drive fails, the data stored on the drive is inaccessible. In a system in which access to data is imperative, there must be a backup system. Most backup systems today involve storing the data on multiple disk drives so that if one drive fails, another drive that contains a copy of the data is available. These multiple disk drives are known as redundant arrays of independent disks (RAIDs). The addition of RAIDs and their associated RAID controllers make a networked storage system more reliable and fault tolerant. Because of its inherent advantages, RAID has quickly become an industry standard.

Conventional enterprise-class RAID controllers employ a backplane as the interconnect between the hosts and the storage devices. A series of host port interfaces are connected to the backplane, as are a series of storage element interfaces. Generally, a centralized cache and transaction/RAID processor are also directly connected to the backplane. Unfortunately, the more host port interfaces and storage element interfaces are added to the backplane, the less performance the overall system possesses. A backplane can only offer a fixed bandwidth, and therefore cannot very well accommodate scalability. The only way, currently, to provide scalability is to add another enterprise-class RAID controller box to the network storage system. Current RAID controller systems, such as Symmetrix by EMC, are large and costly. Therefore, it is often not economically viable to add an entire RAID controller box for the purposes of scalability.

The conventional system is also severely limited in flexibility because it does not offer an architecture that allows any host to access any storage element in the system if there are multiple controllers. Typically, the controller is programmed to control access to certain storage elements from only certain host ports. For other hosts, there is simply no path available to every storage element.

Neither does the conventional system offer a way to coordinate overlapped writes to the RAID with high accuracy, high performance, and low numbers of data collisions.

Attempts have been made to improve system performance by adding scalability enablers and incorporating a direct communications path between the host and storage device. Such a system is described in U.S. Pat. No. 6,397,267, entitled “Redirected I/O for scalable performance storage architecture,” assigned to Sun Microsystems, Inc., which is hereby incorporated by reference. While the system described in this patent may improve system performance by adding scalability, it does not offer an architecture in which any host can communicate with any storage element in the system with multiple controllers.

It is therefore an object of the invention to provide a RAID controller capable of allowing any host port access to any volume through request mapping.

It is yet another object of the present invention to provide a scalable networked storage system architecture.

It is another object of the invention to provide a scalable architecture that allows any host port to communicate with any logical or virtual volume.

It is yet another object of the invention to provide concurrent volume accessibility through any host port.

It is yet another object of this invention to provide a scalable networked storage system architecture that has significantly improved performance over conventional storage systems.

It is yet another object of this invention to provide a scalable networked storage system architecture that is more flexible than conventional storage system architectures.

It is yet another object of the present invention to provide a method and apparatus for coordinating overlapped writes in a networked storage controller/virtual storage engine architecture.

### SUMMARY OF THE INVENTION

The present invention is a RAID controller architecture with integrated map-and-forward function, virtualization, scalability, and mirror consistency. The RAID controller architecture utilizes decentralized transaction processor controllers with decentralized cache to allow for unlimited scalability in a networked storage system. The system provides virtualization through a map-and-forward function in which a virtual volume is mapped to its logical volumes at the controller level. The system also provides a scalable networked storage system control architecture that provides any number of host and/or storage ports in such a way that significantly increases system performance in a low-cost and efficient manner. The system also provides a controller/virtualizer architecture and associated methods for providing mirror consistency in a virtual storage environment in which different hosts may write to the same LBA simultaneously.

### BRIEF DESCRIPTION OF THE DRAWINGS

The foregoing and other advantages and features of the invention will become more apparent from the detailed description of exemplary embodiments of the invention given below with reference to the accompanying drawings, in which:

FIG. 1 is a block diagram for a network storage system architecture in accordance with the current invention;

FIG. 2 is a flow diagram of a method for a map-and-forward function;

FIG. 3 is a flow diagram of a method for a map-and-forward function with virtualization;

FIG. 4 is a block diagram for a scalable networked storage system architecture with serial fibre channel interconnect;

FIG. 5 is an alternate embodiment of a scalable networked storage system control/virtualizer architecture;

FIG. 6 is yet another embodiment of a scalable networked storage system control/virtualizer architecture;

FIG. 7 is a block diagram of a storage virtualization engine architecture;

FIG. 8 is a flow diagram of a method of conflict detection;

FIG. 9 is a flow diagram of a method of coordinating requests; and

FIG. 10 is a flow diagram of a method of conflict resolution.

### DETAILED DESCRIPTION OF THE INVENTION

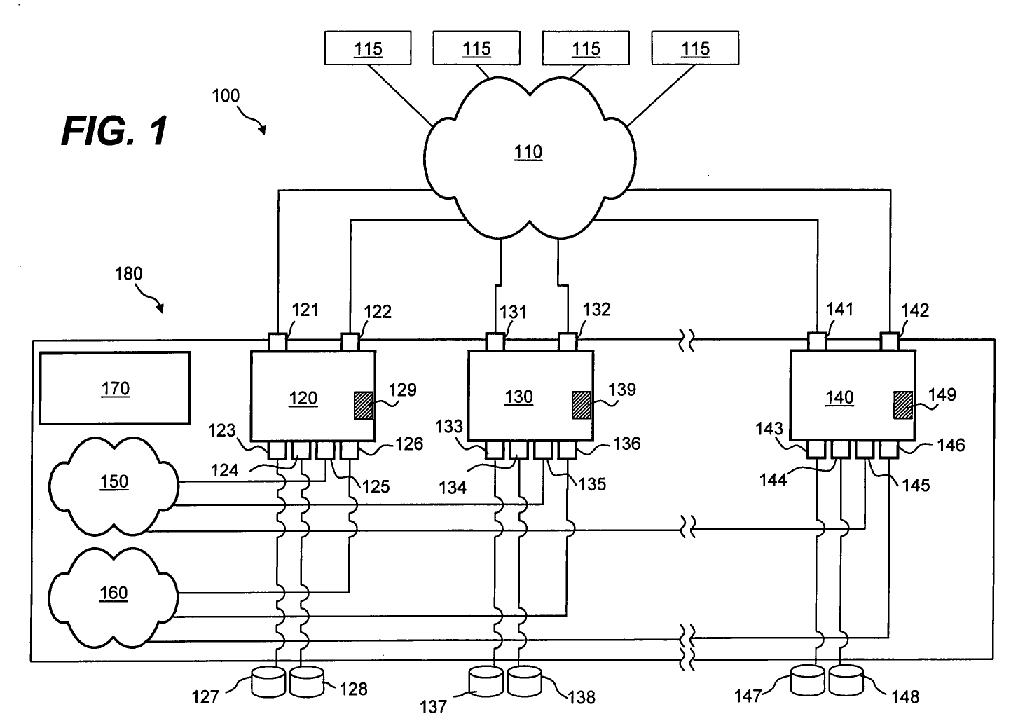

Now referring to the drawings, where like reference numerals designate like elements, there is shown in FIG. 1 a network storage system architecture 100 in accordance with the current invention that includes a network communication fabric 110 and a plurality of hosts 115 (i.e., host₁ 115 to hostₙ 115). Connected to network communication fabric 110 is a storage controller system 180. Storage controller system 180 further includes a RAID controller 1 120, a RAID controller 2 130, and a RAID controller 3 140.

RAID controller 1 120 further includes a host port 1 (H1) 121, a host port 2 (H2) 122, a storage element port 1 (S1) 123, a storage element port 2 (S2) 124, an interconnect interface port 1 (I1) 125, and an interconnect interface port 2 (I2) 126. S1 123 is connected to a storage element 127. S2 124 is connected to storage element 128. I1 125 connects to an interconnect 1 150. I2 126 connects to an interconnect 2 160. RAID controller 1 120 also includes a cache 129.

RAID controller 2 130 further includes a host port 1 (H1) 131, a host port 2 (H2) 132, a storage element port 1 (S1) 133, a storage element port 2 (S2) 134, an interconnect interface port 1 (I1) 135, and an interconnect interface port 2 (I2) 136. S1 133 is connected to a storage element 137. S2 134 is connected to a storage element 138. I1 135 connects to interconnect 1 150. I2 136 connects to interconnect 2 160. RAID controller 2 130 also includes a cache 139.

RAID controller 3 140 further includes a host port 1 (H1) 141, a host port 2 (H2) 142, a storage element port 1 (S1) 143, a storage element port 2 (S2) 144, an interconnect interface port 1 (I1) 145, and an interconnect interface port 2 (I2) 146. S1 143 is connected to a storage element 147. S2 144 is connected to a storage element 148. I1 145 connects to interconnect 1150. I2 146 connects to interconnect 2 160. RAID controller 140 also includes a cache 149.

The configuration shown in networked storage system architecture 100 may include any number of hosts, any number of controllers, and any number of interconnects. For simplicity and ease of explanation, only a representative sample of each is shown. In a topology with multiple interconnects, path load balancing algorithms generally determine which interconnect is used. Path load balancing is fully disclosed in U.S. patent application Ser. No. 10/637,533, filed Aug. 8, 2003, which is hereby incorporated by reference.

RAID controller 1 120, RAID controller 2 130, and RAID controller 3 140 are each based on Aristos Logic pipelined transaction processor-based I/O controller architecture as fully disclosed in U.S. patent application Ser. No. 10/429,048, entitled “System and Method for Scalable Transaction Processing” and U.S. patent application Ser. No. 09/716,195, entitled, “Integrated I/O Controller,” the disclosures of which are hereby incorporated by reference.

Storage controller system 180 may or may not physically include a system configuration controller 170. System configuration controller 170 may physically reside outside storage controller system 180 and its information may enter through one of the host ports. The information provided by system configuration controller 170 may be obtained by the RAID controllers from hosts 115 or from another device connected to network communication fabric 110. System configuration controller 170 provides information required by the RAID controllers to perform store-and-forward and map-and-forward operations. This information may include volume mapping tables, lists of volume controllers, setup information, and control information for volumes recently brought online. In this example, storage configuration controller 170 has established logical volume 1 as residing on storage element 127 and storage element 128. Both storage element 127 and storage element 128 are controlled by RAID controller 1 120. Similarly, storage configuration controller 170 may also establish logical volume 2 as residing on storage element 137 and storage element 138, which are controlled by RAID controller 2 130. Finally, storage configuration controller 170 may establish logical volume 3 as residing on storage element 147 and storage element 148, which are controlled by RAID controller 3 140. Storage configuration controller 170 updates each RAID controller with logical volume assignments for all RAID controllers within storage controller system 180.

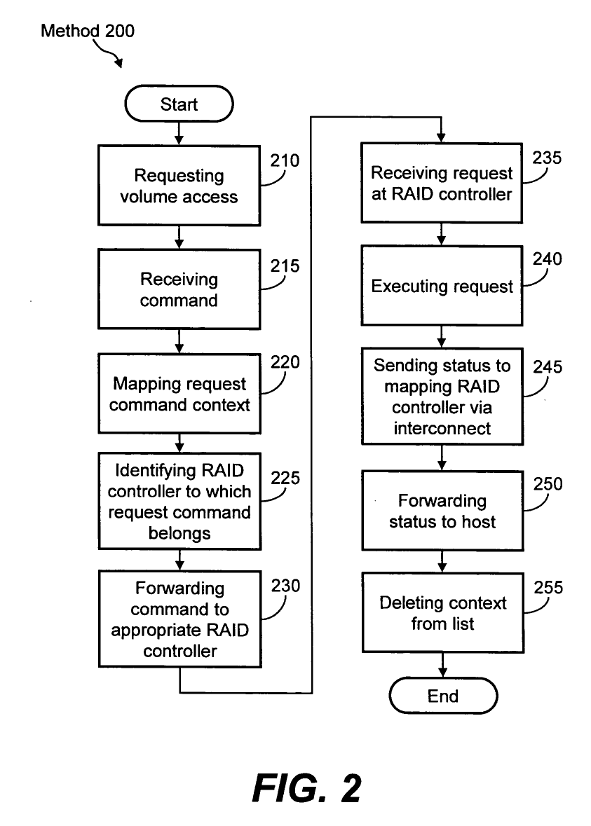

In operation, any host 115 may send a write request to any volume in storage controller system 180 via any RAID controller and the write will be performed correctly. In one example, host₁ 115 requests a write to volume 1. In this example, host₁ 115 sends the request to RAID controller 2 130 via network communication fabric 110. RAID controller 2 130 knows which elements own the volume from volume mapping information supplied by system configuration controller 170; RAID controller 2 130 also knows that volume 1 is physically composed of storage element 127 and storage element 128, which belong to RAID controller 1 120. RAID controller 2 130 stores the write command in its cache 139 and forwards the write request to RAID controller 1 120 for storage element 127 and storage element 128. When RAID controller 1 120 has completed the write request, it sends a write complete status back to RAID controller 2 130. RAID controller 2 130 then forwards the write complete status back to host₁ 115 and deletes the original stored command. This operation is explained in detail in reference to FIG. 2.

FIG. 2 shows a flow diagram of a method 200 for a map-and-forward function as described above. In this example, host₁ 115 requests a write action to volume 1 through RAID controller 2 130.

Step 210: Requesting Volume Access

In this step, host₁ 115 requests a write action on H1 131 of RAID controller 2 130. The request is routed through network communication fabric 110 to H1 131 of RAID controller 2 130. Method 200 proceeds to step 215.

Step 215: Receiving Command

In this step, RAID controller 2 130 receives the command from host₁ 115 at port H1 131. Method 200 proceeds to step 220.

Step 220: Mapping Request Command Context

In this step, RAID controller 2 130 maps the volume 1 request in cache 139. Method 200 proceeds to step 225.

Step 225: Identifying Raid Controller to which Request Command Belongs

In this step, RAID controller 2 130 uses volume mapping information previously supplied by system configuration controller 170 to determine that RAID controller 1 120 controls the requested volume 1 on storage element 127 and storage element 128. Method 200 proceeds to step 230.

Step 230: Forwarding Command to Appropriate RAID Controller

In this step, RAID controller 2 130 forwards the write command from I1 135 through interconnect 1 150 to RAID controller 1 120. Method 200 proceeds to step 235.

Step 235: Receiving Request at RAID Controller

In this step, the command arrives at RAID controller 1 120 at port I1 125. Method 200 proceeds to step 240.

Step 240: Executing Request

In this step, RAID controller 1 220 executes the write command to volume 1 on storage element 127 and storage element 128. When the write operation is complete, method 200 proceeds to step 245.

Step 245: Sending Status to Mapping RAID Controller Via Interconnect

In this step, RAID controller 1 120 sends the status of the write operation back to RAID controller 2 130 via interconnect 1 150. RAID controller 1 120 sends the status through port I1 125 in this example. Method 200 proceeds to step 250.

Step 250: Forwarding Status to Host

In this step, RAID controller 2 130 forwards the status received from RAID controller 1 120 back through network communication fabric 110 to host₁ 115. Method 200 proceeds to step 255.

Step 255: Deleting Context from List

In this step, RAID controller 2 130 deletes the original request from its list in cache 139. This concludes method 200 for executing a map-and-forward command. Method 200 repeats for the next map-and-forward transaction.

Storage controller systems often employ the use of several storage devices to redundantly store data in case one or more storage devices fail (e.g., mirroring). In a like manner, several storage devices may be used in parallel to increase performance (striping). In more complex systems, these combinations may span RAID controllers, so a “virtual” volume may reside on storage devices that are controlled by more than one RAID controller. This allows much greater flexibility in storage resource management, allowing volume size, performance, and reliability to change as users' needs change. However, it would be very inefficient for hosts to be required to keep track of all the various logical and physical combinations, so a layer of abstraction is needed. This is the concept of storage virtualization, in which the internal functions of a storage subsystem or service are essentially hidden from applications, computer servers, or general network resources for the purpose of enabling application and network independent management of storage or data. In a virtualized network storage system architecture, hosts request access to virtual volumes, which may consist of any number of storage elements controlled by any number of RAID controllers. For example, with reference to FIG. 1, using virtualization, the system may create a virtual volume 4 that consists of logical volume 1, which maps to physical storage element 127, and logical volume 3, which maps to storage element 147, where logical volume 3 is a mirror of logical volume 1. Therefore, when a host wants to store data, the host requests a write to virtual volume 4 and the storage controller system interprets the write request, maps the requests to the logical volumes and hence to the appropriate RAID controllers, and physically writes the data to storage element 147 and storage element 127.

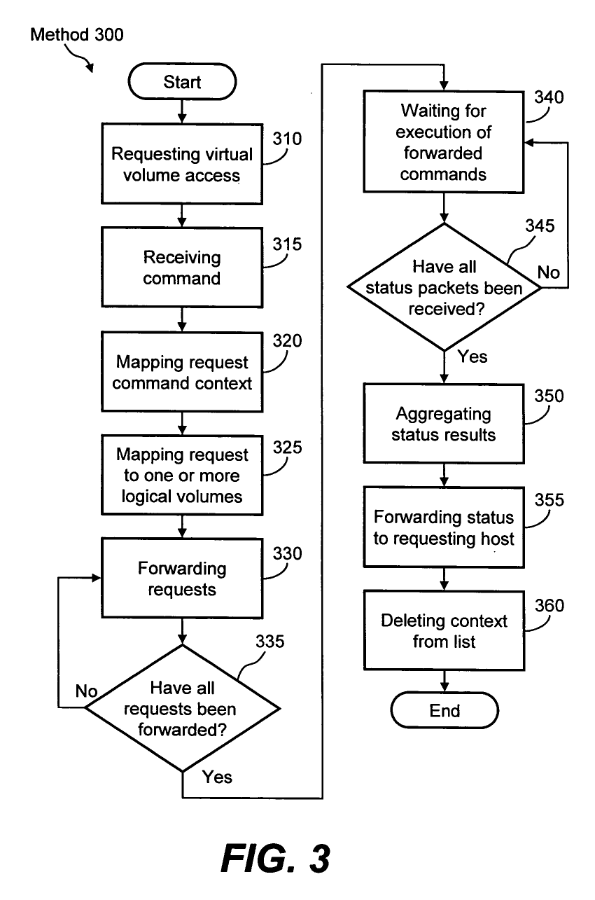

FIG. 3 shows a method 300 of a map-and-forward function with virtualization. The following example describes a write command to virtual volume 4. In this example, as described above, virtual volume 4 consists of logical volume 1 and logical volume 3. Logical volume 1 is controlled by RAID controller 120 and logical volume 3 is controlled by RAID controller 3 140. Therefore, a request to write to virtual volume 4 results in a write request to logical volume 1 and logical volume 3. This example is fully explained in the steps below.

Step 310: Requesting Virtual Volume Access

In this step, host₁ 115 sends a request for a write to virtual volume 4 to RAID controller 2 130 via network communication fabric 110. Method 300 proceeds to step 315.

Step 315: Receiving Command

In this step, RAID controller 2 130 receives the volume 4 write command at port H1 131. Method 300 proceeds to step 320.

Step 320: Mapping Request Command Context

In this step, RAID controller 2 130 stores the volume 4 request in cache 139. Method 300 proceeds to step 325.

Step 325: Mapping Request Command to One or More Logical Volumes

In this step, RAID controller 2 130 uses information previously supplied by system configuration controller 170 to determine that virtual volume 4 is composed of logical volumes 1 and 3. RAID controller 2 130 further determines that RAID controller 1 120 controls logical volume 1 and that RAID controller 3 140 controls logical volume 3. RAID controller 2 130 stores the context of each of these new commands. Method 300 proceeds to step 330.

Step 330: Forwarding Requests

In this step, RAID controller 2 130 forwards a request to one of the RAID controllers determined to control the involved logical volumes via the corresponding interconnect. Method 300 proceeds to step 335.

Step 335: Have all Requests Been Forwarded?

In this decision step, RAID controller 2 130 checks to see if all of the pending requests have been forwarded to the correct controller. If yes, method 300 proceeds to step 340; if no, method 300 returns to step 330.

Step 340: Waiting for Execution of Forwarded Commands

In this step, RAID controller 2 130 waits for the other RAID controllers to finish executing the commands. The flow of execution is identical to the execution of step 235, step 240, and step 245 of method 200. In this example, RAID controller 1 120 receives its command at I1 125 from interconnect 1 150. RAID controller 1 120 then executes the write command to storage element 127. Finally, RAID controller 1 120 sends a status packet back to RAID controller 2 130 via interconnect 1 150. RAID controller 2 130 receives the status packet at I1 135. Concurrently, RAID controller 3 140 receives its command at I2 146 from interconnect 2 160. RAID controller 140 then executes the write command to storage element 147. Finally, RAID controller 3 140 sends a status packet back to RAID controller 2 130 via interconnect 2 160. RAID controller 2 130 receives the status packet at I2 136. Method 300 proceeds to step 345.

Step 345: Have all Status Packets Been Received?

In this decision step, RAID controller 2 130 determines whether all of the forwarded requests have been processed by checking to see if a status packet exists for each transaction. If yes, method 300 proceeds to step 350; if no, method 300 returns to step 340.

Step 350: Aggregating Status Results

In this step, RAID controller 2 130 aggregates the status results from each transaction into a single status packet. Method 300 proceeds to step 355.

Step 355: Forwarding Status to Requesting Host

In this step, RAID controller 2 130 forwards the aggregated status packet back to the original requesting host₁ 115 via network communication fabric 110. Method 300 proceeds to step 360.

Step 360: Deleting Context from List

In this step, RAID controller 2 130 deletes the original write request. Method 300 ends.

Network storage system architecture 100 can employ the map-and-forward function for storage virtualization. The map-and-forward function maps a single request to a virtual volume into several requests for many logical volumes and forwards the requests to the appropriate RAID controller. A single request that applies to a single logical volume is a store-and-forward function. A store-and-forward function is a simple case of the map-and-forward function in which the controller maps one request to one logical volume.

Network storage system architecture 100 allows any port to request any volume, either logical or virtual, and to have that request accurately serviced in a timely manner. Network storage system architecture 100 forwards this capability inherently. Conventional network storage system architectures require additional hardware such as a switcher in order to provide the same functionality. Network storage system architecture 100 also provides a scalable architecture that allows any host port to communicate with any logical or virtual volume, regardless of the number of added hosts and/or volumes. Additionally, network storage system architecture 100 provides concurrent volume accessibility through any host port due to the incorporation of decentralized cache and processing. Finally, network storage system architecture 100 may be used in any loop topology system such as Infiniband, fibre channel, Ethernet, ISCSI, SATA, or other similar topologies.

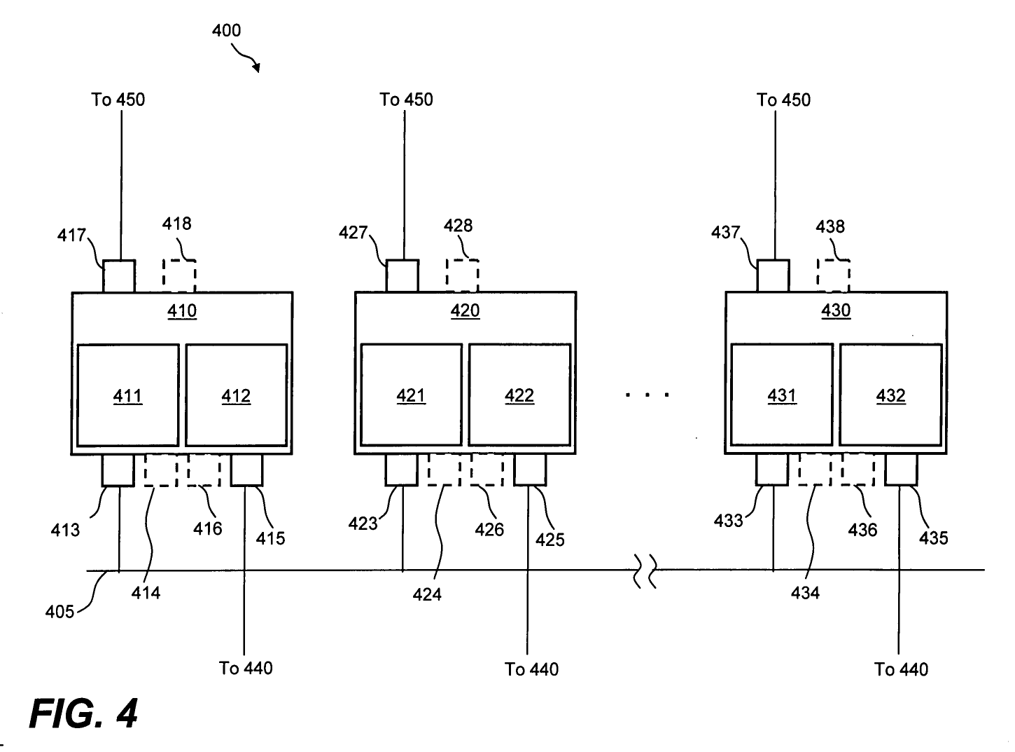

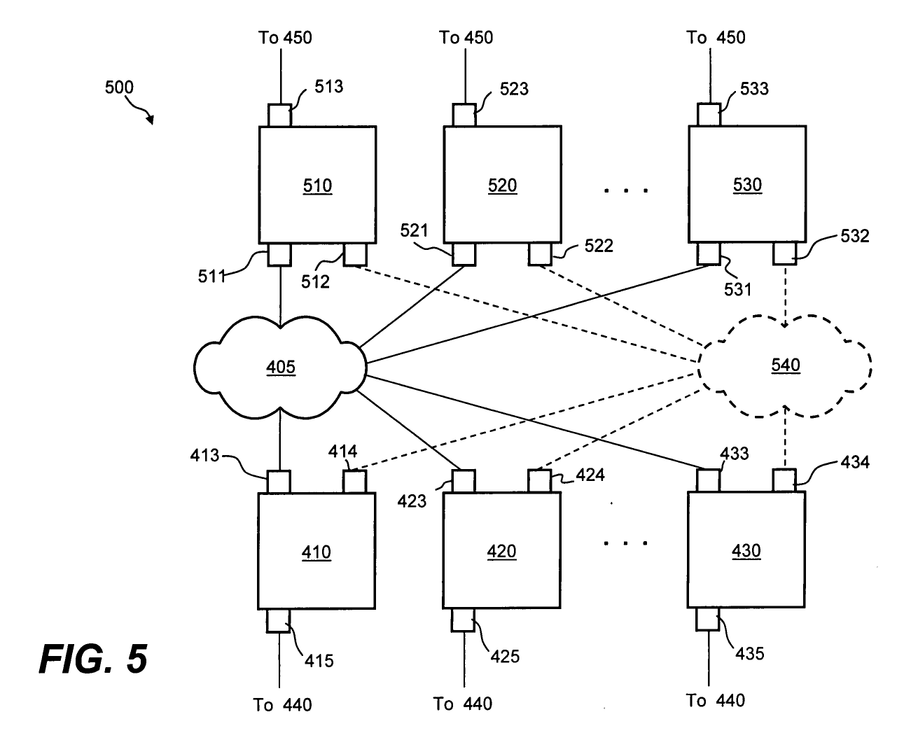

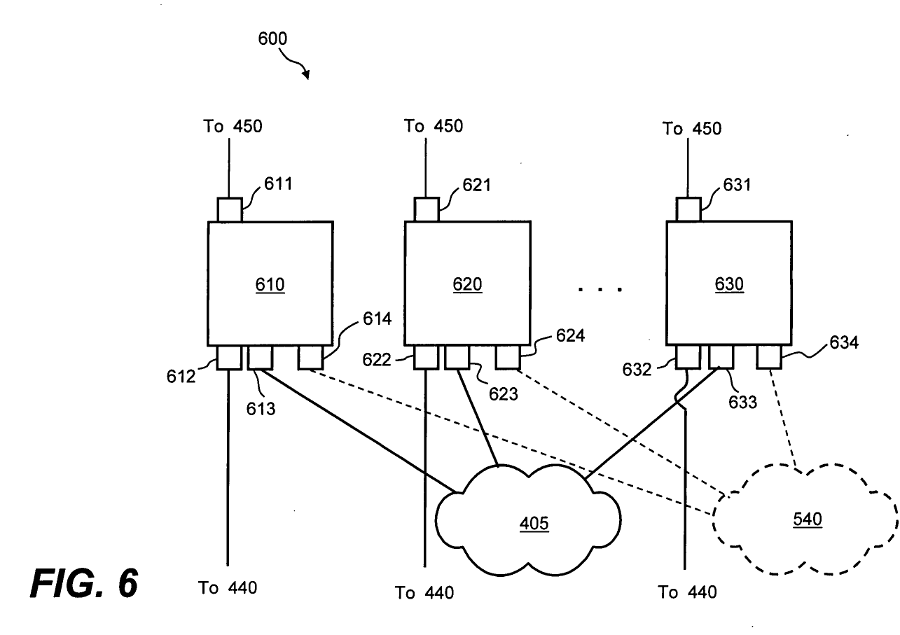

In an alternative embodiment, network storage system architecture 100 may be configured as a modularly scalable networked storage system architecture with a serial interconnect. FIG. 4 illustrates this architecture. FIG. 5 and FIG. 6 illustrate variations on this architecture with the addition of virtualization features.

FIG. 4 is a block diagram for a scalable networked storage system control architecture 400 that incorporates a serial fibre channel interconnect 405. Fibre channel interconnect 405 is a high-speed data serial interconnect topology, such as may be based one of the fibre channel protocols, and may be either a loop or a switched interconnect. Fibre channel interconnect 405 eliminates the need for a conventional backplane interconnect, although the configuration is compatible with and may communicate with any number of conventional networked storage system controller types. Coupled to fibre channel interconnect 405 is a storage controller module 1 (SCM1) 410. SCM1 410 further includes a cache 411 and a processing element 412. Also included in SCM1 410 are a host port 417, an interconnect port 413, and a storage port 415. SCM1 410 may have multiple ports of each type, such as another host port 418, another interconnect port 414, and another storage port 416. Thus, SCM1 410 is, in and of itself, scalable. Scalable networked storage system control architecture 400 is further scalable by adding more SCMs to fibre channel interconnect 405. An SCM2 420 is another instantiation of SCM1 410, and further includes a cache 421, a processing element 422, a host port 427, an interconnect port 423, and a storage port 425, as well as the potential for multiple ports of each type, such as another host port 428, another interconnect port 424, and another storage port 426. An SCMn 430 is yet another instantiation of SCM1 410, and further includes a cache 431, a processing element 432, a host port 437, an interconnect port 433, and a storage port 435, as well as the potential for multiple ports of each type, such as another host port 438, another interconnect port 434, and another storage port 436. (In general, “n” is used herein to indicate an indefinite plurality, so that the number “n” when referred to one component does not necessarily equal the number “n” of a different component). Host ports 417, 427, and 437 are connected to a series of hosts 450 via fibre channel networks in this example. Host ports 418, 428, and 438 may also be connected to hosts 450 through a fibre channel interconnect. Interconnect ports 413, 423, and 433 are coupled to fibre channel interconnect 405. Interconnect ports 414, 424, and 434 may also be coupled to fibre channel interconnect 405. Storage ports 415, 425, and 435 are coupled to a series of storage devices 440 via fibre channel means. Storage ports 416, 426, and 436 may also be coupled to storage devices 440 via fibre channel means.

SCM1 410, SCM2 420, and SCMn 430 are each modeled from Aristos Logic pipelined transaction processor-based I/O controller architecture, as fully disclosed in U.S. patent application Ser. Nos. 10/429,048 and 09/716,195, previously incorporated herein by reference.

Scalable networked storage system control architecture 400 has distributed cache, unlike a conventional centralized cache. Each time an SCM is added to scalable networked storage system control architecture 400, there is more available cache; therefore, cache throughput is no longer a factor in the degradation of system performance. Similarly, since each SCM has its own processing element, every time a new SCM is added to scalable networked storage system control architecture 400, more processing power is also added, thereby increasing system performance. In fact, the additional cache and processing elements enhance and significantly improve system performance by parallelizing the transaction process in networked storage systems.

Recently, fibre channel switches have become very inexpensive, making a switched fibre channel network a viable option for inter-controller interconnects. With a switched fibre channel network, scalable networked storage system control architecture 400 scales proportionally with interconnect bandwidth. In other words, the more SCMs that are added to the system, the more bandwidth the interconnect fabric has to offer. A looped fibre channel is also an option. Although it costs less to implement a looped fibre channel than a switched fibre channel, a looped fibre channel offers only a fixed bandwidth, because data must always travel in a certain path around the loop until it reaches its destination and may not be switched to its destination directly. Scalable storage system control architecture 400 may also be used with a loop-switch type of topology, which is a combination of loop and switched architectures. Other topologies such as 3GIO, Infiniband, and ISCSI may also be used as the inter-controller interconnect.

As previously described, storage virtualization can hide the internal functions of a storage subsystem or service from applications, computer servers, or general network resources for the purpose of enabling application and network independent management of storage or data. For example, a hidden internal function exists in the situation where a storage element is a mirror of another storage element. Using virtualization, a scalable networked storage system control/virtualizer architecture may create a virtual volume that maps to both physical storage elements. Therefore, when a host wants to store data it writes to the virtual volume, and the RAID controller system physically writes the data to both storage elements. Virtualization is becoming widely used in network storage systems due to use of RAID architectures and the overhead reduction that it enables for the hosts. The hosts see only simplified virtual volumes and not the physical implementation of the RAID system.

FIG. 5 shows a scalable networked storage system control/virtualizer architecture 500, which is a separate embodiment of scalable networked storage system control architecture 400. FIG. 5 shows SCM1 410, SCM2 420, and SCMn 430 coupled to fibre channel interconnect 405 via interconnect port 413, interconnect port 423, and interconnect port 433, respectively. Also coupled to fibre channel interconnect 405 are a virtualizer module 1 (VM1) 510, a VM2 520, and a VMn 530 via an interconnect port 511, an interconnect port 521, and an interconnect port 531, respectively. VM1 510 is an identical instantiation of SCM1 410; however, in this architecture it is used as a virtual interface layer between fibre channel interconnect 405 and hosts 450. VM1 510 may map logical volumes of storage devices 440 to virtual volumes requested by hosts 450. The logical volume mapping process is transparent to hosts 450 as well as to SCM1 410, SCM2 420, and SCMn 430. Virtualizers can coordinate through fibre channel interconnect 405.

Another advantage of VM1 510 is the fact that its interconnect ports may be used for any type of interconnect (i.e., host interconnect, storage interconnect, etc). For example, interconnect port 511 is shown as an interconnect port in FIG. 5; however, it may also be configured to act as a storage interconnect port or as a host interconnect port. SCM1 410 has the flexibility to use a single interconnect port 413 as both an interconnect port and a storage interconnect port at various, separate times. The architecture also allows for more than one fibre channel interconnect 405, for example, a redundant interconnect 540, which is shown coupled to a plurality of redundant interconnect ports, including an interconnect port 512, an interconnect port 522, and an interconnect port 532. SCM1 410, SCM2 420, and SCMn 430 may also be coupled to redundant interconnect 540 via interconnect port 414, interconnect port 424, and interconnect port 434, respectively. The use of redundant interconnect 540 provides the system with more interconnect bandwidth. Modules now have an alternative means through which they may communicate. For example, VM1 510 may relay a write request from hosts 450 to SCMn 430 via redundant interconnect 540 into interconnect port 434. At the same time, SCMn 430 may send the write acknowledge to interconnect port 511 of VM1 510 via fibre channel interconnect 405. This illustrates an example not only of the system flexibility but also of the increased system communication bandwidth.

FIG. 6 shows scalable networked storage system incorporated control/virtualizer architecture 600, which is yet another embodiment of scalable networked storage system control architecture 400. Scalable networked storage system incorporated control/virtualizer architecture 600 includes a combined virtualizer/storage control module 1 (V/SCM1) 610, a V/SCM2 620, and a V/SCMn 630. The V/SCM components are combined functional instantiations of the SCMs and VMs described with reference to FIGS. 4 and 5. V/SCM1 610 is coupled to fibre channel interconnect 405 via an interconnect port 613 and may also be coupled to redundant interconnect 540 via an interconnect port 614 for increased bandwidth. V/SCM2 620 is coupled to fibre channel interconnect 405 via an interconnect port 623 and may also be coupled to redundant interconnect 540 via an interconnect port 624. Similarly, V/SCMn 630 is coupled to fibre channel interconnect 405 via an interconnect port 633 and may also be coupled to redundant interconnect 540 through an interconnect port 634. V/SCM1 610 is further coupled to storage devices 440 via a storage port 612. V/SCM2 620 and V/SCMn 630 are also coupled to storage devices 440 via a storage port 622 and a storage port 632, respectively. This topology minimizes the size of the controller architecture by combining the functionality of both the storage controllers and the virtualizers in a single component. This topology provides the greatest scalable system performance for the least cost.

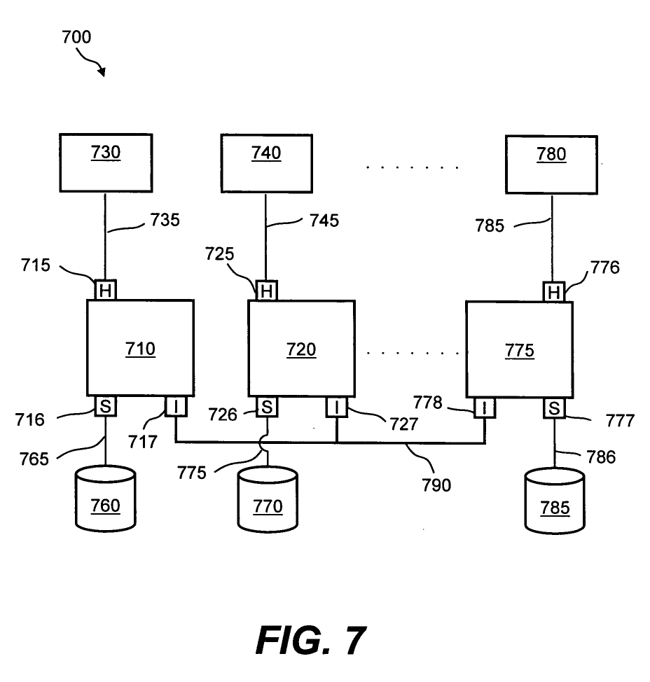

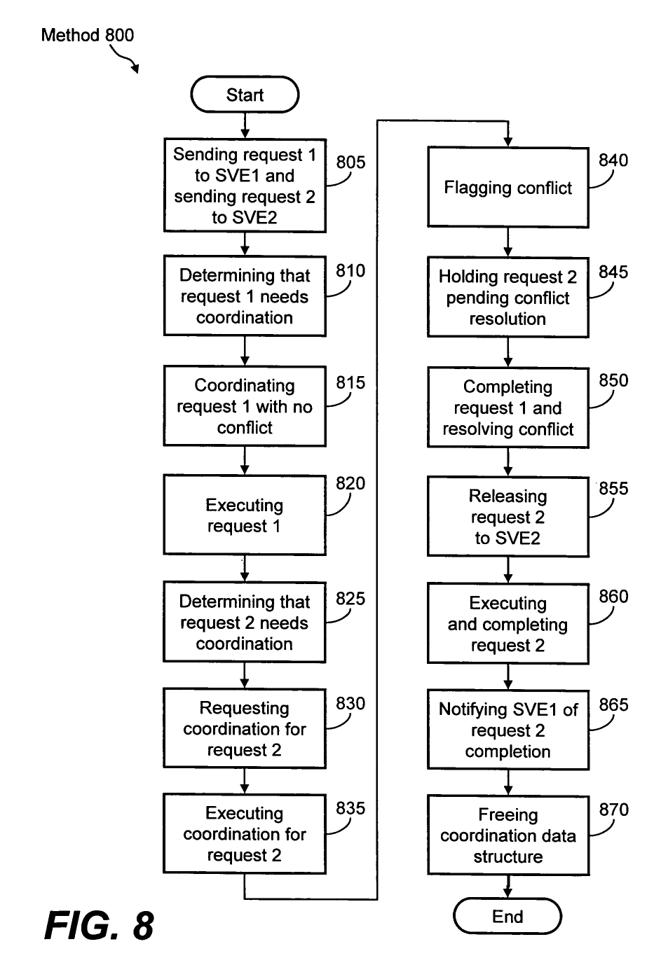

In an alternative embodiment, network storage system architecture 100 may be configured to provide accurate handling of simultaneous, overlapped writes from multiple hosts to the same logical block address (LBA). This configuration assumes that the virtualizer engine does not employ a RAID 5 architecture, obviating stripe coherency as an obstacle. FIG. 7 illustrates this mirror consistency architecture. FIG. 8 illustrates a method of conflict detection that utilizes this architecture.

FIG. 7 is a block diagram of a storage virtualization engine architecture 700 that includes a plurality of storage virtualization engines (SVEs), including an SVE1 710, an SVE2 720, and an SVEn 775. Storage virtualization engine architecture 700 further includes a plurality of hosts, including a host 1 730, a host 2 740, and a host n 780. Storage virtualization engine architecture 700 also includes a plurality of storage elements (SEs), including an SE1 760, an SE2 770, and an SEn 785. Storage virtualization engine architecture 700 also includes a plurality of host networks (HNs), including an HN1 735, an HN2 745, and an HNn 785, and a plurality of storage buses (SBs), including SB 765, SB 775, and SB 786.

SVE1 710 further includes a host interface 715, a storage interface 716, and an intercontroller interface 717.

SVE2 720 further includes a host interface 725, a storage interface 726, and an intercontroller interface 727.

SVEn 775 further includes a host interface 776, a storage interface 777, and an intercontroller interface 778.

For this example, SE1 760 is coupled to SVE1 710 through storage interface 716 via storage bus 765, SE2 770 is coupled to SVE2 720 through storage interface 726 via storage bus 775, and SEn 785 is coupled to SVEn 775 through storage interface 777 via storage bus 786. Furthermore, SVE1 710, SVE2 720, and SVEn 775 are coupled through their respective intercontroller interfaces via a virtualizer interconnect 790. In storage virtualization engine architecture 700, one storage virtualization engine is designated as the coordinator at the system level. The others are configured to recognize which of the other SVEs is the coordinator. The rule for coordination is as follows: any virtual volume request resulting in two or more storage element requests requires coordination, even if there is no conflict with another request. In other words, a request to a virtual volume that translates to either a read or a write request to two or more storage elements needs to be coordinated to avoid data mirroring inconsistencies. The following flow diagram illustrates the process for detecting a possible data inconsistency problem, coordinating the storage virtualizer engines, and resolving any conflicts before they become problems.

FIG. 8 is a flow diagram of a method 800 of conflict detection. For this example, SVE1 710 is the coordinator of the system for target volumes residing on SE1 760, SE2 770, and/or SEn 785. In this example, request 1 and request 2 are both write commands to the same LBA of a virtual volume that includes SE1 760 and the mirror SE2 770.

Step 805: Sending Request 1 to SVE1 and Sending Request 2 to SVE2

In this step, host 1 730 sends request 1 to SVE1 710, and host 2 720 sends request 2 to SVE2 720. Method 800 proceeds to step 810.

Step 810: Determining that Request 1 Needs Coordination

In this step, SVE1 710 determines that request 1 requires coordination because it is a write request to two mirrored logical volumes, i.e., SE1 760 and SE2 770. Method 800 proceeds to step 815.

Step 815: Coordinating Request 1 with No Conflict

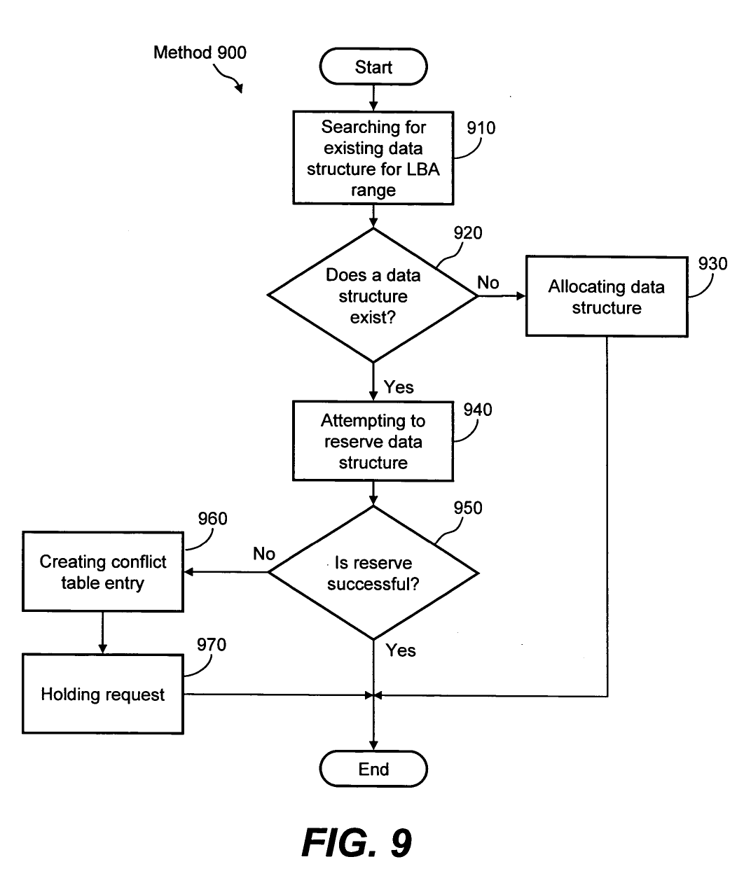

In this step, SVE1 710 coordinates request 1 and determines that there is no conflict. The coordination process is described in more detail with reference to FIG. 9. Method 800 proceeds to step 820.

Step 820: Executing Request 1

In this step, SVE1 710 executes request 1. Method 800 proceeds to step 825.

Step 825: Determining that Request 2 Needs Coordination

In this step, SVE2 720 determines that request 2 needs coordination because it is a write request to two mirrored logical volumes, i.e., SE1 760 and SE2 770. Method 800 proceeds to step 830.

Step 830: Requesting Coordination for Request 2

In this step, because SVE2 720 recognizes that SVE1 710 is the system coordinator for requests involving SE1 760 and SE2 770, SVE2 720 requests coordination for request 2 from SVE1 710. Method 800 proceeds to step 835.

Step 835: Executing Coordination for Request 2

In this step, SVE1 710 executes coordination for request 2 and finds conflict. Method 800 proceeds to step 840.

Step 840: Flagging Conflict

In this step, SVE1 710 flags the conflict and records the conflict into a local table. Method 800 proceeds to step 845.

Step 845: Holding Request 2 Pending Conflict Resolution

In this step, SVE1 710 holds request 2 pending resolution of the conflict. Method 800 proceeds to step 850.

Step 850: Completing Request 1 and Resolving Conflict

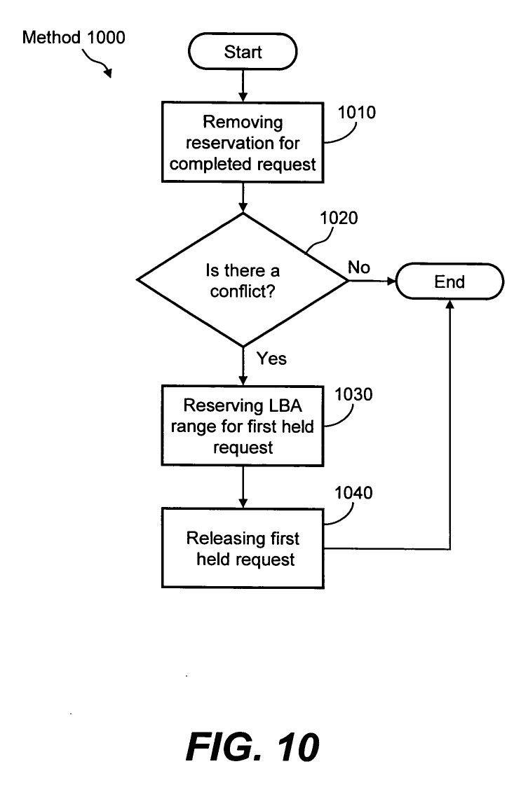

In this step, SVE1 710 completes request 1 and resolves the conflict. The conflict resolution process is fully described with reference to FIG. 10. Method 800 proceeds to step 855.

Step 855: Releasing Request 2 to SVE2

In this step, SVE1 710 releases request 2 to SVE2 720. Method 800 proceeds to step 860.

Step 860: Executing and Completing Request 2

In this step, SVE2 720 executes and completes request 2. Method 800 proceeds to step 865.

Step 865: Notifying SVE1 of Request 2 Completion

In this step, SVE2 720 notifies SVE1 710 of the completion of request 2. Method 800 proceeds to step 870.

Step 870: Freeing Coordination Data Structure

In this step, SVE1 710 frees the coordination data structure. Method 800 ends.

The overall system performance may be negatively impacted by this type of configuration. The additional overhead required and the processing time lost while requests are being held is addressed in the preferred embodiment. The preferred embodiment for storage virtualization engine architecture 700 uses a pipelined transaction processor-based I/O controller architecture as fully disclosed in U.S. patent application Ser. Nos. 10/429,048 and 09/716,195, previously incorporated by reference. A request coordination process is further described with reference to FIG. 9.

FIG. 9 is a flow diagram of a method 900 of coordinating requests. Method 900 is an elaboration of each of the coordination steps, i.e., step 815 and step 835, of method 800. In the example examined in method 800, there are two coordination steps due to the two host requests. However, there may be any number of coordination steps, depending on the number of overlapping requests in a storage system.

Step 910: Searching for Existing Data Structure for LBA Range

In this step, SVE1 710 searches for an existing data structure for the LBA range in question. Method 900 proceeds to step 920.

Step 920: does a Data Structure Exist?

In this decision step, method 900 checks existing tables of data structures to determine whether a data structure exists for the particular LBA range in question. If yes, method 900 proceeds to step 940; if no, method 900 proceeds to step 930.

Step 930: Allocating Data Structure

In this step, SVE1 710 allocates a data structure for the required LBA range. Method 900 ends.

Step 940: Attempting to Reserve Data Structure

In this step, SVE1 710 attempts to reserve a data structure for the LBA range of request. Method 900 proceeds to step 950.

Step 950: is Reserve Successful?

In this decision step, method 900 determines whether the reserve is successful. If yes, method 900 ends; if no, method 900 proceeds to step 960.

Step 960: Creating Conflict Table Entry

In this step, SVE1 710 creates a record of conflict by adding an entry to a table that records all the conflicts. Method 900 proceeds to step 970.

Step 970: Holding Request

In this step, SVE1 710 holds the request (in this example, request 2) until the conflict has been resolved (see method illustrated in FIG. 10). Method 900 ends.

FIG. 10 is a flow diagram of a method 1000 of conflict resolution. Method 1000 is a detailed view of the conflict resolution step 850 of method 800.

Step 1010: Removing Reservation for Completed Request

In this step, SVE1 710 removes the reservation for the completed request. Method 1000 proceeds to step 1020.

Step 1020: Is there a Conflict?

In this decision step, SVE1 710 determines whether there is an existing conflict between two requests. If so, method 1000 proceeds to step 1030; if not, method 1000 ends.

Step 1030: Reserving LBA Range for First Held Request

In this step, SVE1 710 reserves the LBA range for the first held request (in this case, for request 2). Method 1000 proceeds to step 1040.

Step 1040: Releasing First Held Request

In this step, SVE1 710 releases the first held request by relinquishing execution to SVE2 720. Method 1000 ends.

In summary, method 900 and method 1000 each repeat as often as needed to provide request coordination and conflict resolution, respectively. As a rule, any request requiring access to multiple storage elements warrants the need for coordination. Every request flagged as needing coordination does not necessarily constitute a conflict. However, those that do present conflicts are flagged and treated as such. As each conflict in storage virtualization engine architecture 700 is detected, the designated coordinating storage/virtualization controller adds the conflict to a conflict list and resolves each conflict in order of detection.

While the invention has been described in detail in connection with the exemplary embodiment, it should be understood that the invention is not limited to the above disclosed embodiment. Rather, the invention can be modified to incorporate any number of variations, alternations, substitutions, or equivalent arrangements not heretofore described, but which are commensurate with the spirit and scope of the invention. Accordingly, the invention is not limited by the foregoing description or drawings, but is only limited by the scope of the appended claims.

1. A method for processing a host command in a storage system including a plurality of storage elements coupled to a plurality of storage controllers, the method comprising the steps of:
at a first one of said plurality of storage controllers,
receiving a host command directed to a volume of said storage system;
determining a target storage element of said storage system corresponding to said volume;
determining a target storage controller from said plurality of storage controllers corresponding to said target storage element;
if said target storage controller is not said first one of said plurality of storage controllers, forwarding the host command to said target storage controller;
at the target storage controller,
receiving the host command forwarded by the first one of said plurality of controllers;
executing said host command;
forwarding, to said first one of said plurality of storage controllers, an execution status associated with said host command; and
at said first one of said plurality of storage controllers,
receiving said execution status; and
forwarding said execution status to said host.

2. The method of claim 1, wherein said step of determining a target storage controller comprises searching a mapping table.

3. The method of claim 2, further comprising the step of:
before receiving a host command at said first one of said plurality of storage controllers, creating said mapping table to reflect a mapping between volumes and controllers of said storage system.

4. A method for processing a host command in a storage system including a plurality of storage elements coupled to a plurality of storage controllers, the method comprising the steps of:
at a first one of said plurality of storage controllers,
receiving a host command directed to a virtual volume of said storage system;
determining a plurality of logical volumes of said storage system corresponding to said virtual volume;
determining a plurality of target storage controllers from said plurality of storage controllers corresponding to said plurality of logical volumes;
sending a component command to each of said plurality of target storage controllers, the component command for a particular one of said plurality of target storage controllers corresponding to at least a portion of the host command and relating to the logical volume associated with the particular target controller;
at each of said plurality of the target storage controllers,
receiving the component command sent by the first one of said plurality of controllers;
executing said component command;
forwarding, to the first one of said plurality of storage controller, an execution status; and
at said first one of said plurality of storage controllers,
receiving said execution status from each one of said plurality of target storage controllers;
determining an aggregate host command execution status from said received execution status; and
forwarding said aggregate host command status to said host.

5. The method of claim 4, wherein said step of determining a plurality of target storage controllers comprises searching a mapping table.

6. The method of claim 5, further comprising the step of:
before receiving a host command at said first one of said plurality of storage controllers, creating said mapping table to reflect a mapping between virtual volumes and logical volumes of said storage system.

7. A storage system, comprising:
a plurality of storage controllers, each one of said plurality of storage controllers comprising:
at least one host port for communicating with a plurality of hosts; and
at least one storage element port for communicating with a plurality of storage elements;
an interconnect connected to each of said plurality of storage controllers; and
at least one storage element, each storage element being coupled to a respective storage element port;
wherein said plurality of storage controllers further comprise means for processing a host command received on any host port targeted to a storage volume on any one of said plurality of storage elements.

8. The storage system of claim 7, further comprising:
a configuration controller for setting up mappings between storage volumes and storage elements.

9. A storage system, comprising:
a plurality of storage controllers, each one of said plurality of storage controllers comprising:
at least one host port for communicating with a plurality of hosts; and
at least one storage element ports for communicating with a plurality of storage elements;
an interconnect connected to each of said plurality of storage controllers; and
at least one storage element, each storage element being coupled to a respective storage element port;
wherein said plurality of storage controllers further comprise means for processing a host command received on any host port targeted to a virtual volume on said plurality of storage elements.

10. The storage system of claim 9, further comprising:
a configuration controller for setting up mappings between virtual volumes and logical volumes.

11. A scalable storage controller, comprising:
a high speed interconnect;
a plurality modules, each of said plurality of modules comprising:
a cache memory;
an interconnect port, coupled to said high speed interconnect;
a storage port, for coupling to a storage device;
a host port, for coupling to a host; and
a processing element, coupled to said cache memory, said interconnect port, said storage port, and said host port.

12. The scalable storage controller of claim 11, wherein said high speed interconnect is a serial interconnect.

13. The scalable storage controller of claim 11, wherein said high speed interconnect is a fibre channel loop.

14. The scalable storage controller of claim 11, wherein said high speed interconnect is a switched serial network.

15. A scalable storage controller, comprising:
a primary interconnect; and
a plurality of modules, each of said plurality of modules comprising:
a cache memory;
an interconnect port, coupled to said primary fibre channel interconnect;
a storage port, for coupling to a storage device;
a host port, for coupling to a host; and
a processing element, coupled to said cache memory, said interconnect port, said storage port, and said host port;
wherein the processing element of each of said modules are configured to process a host command for accessing a virtual volume by causing each module associated with said virtual volume to access its respective storage device.

16. The scalable storage controller of claim 15, further comprising:
a redundant interconnect;
wherein each of said modules further comprises another interconnect port coupled to said redundant interconnect.

17. In a storage controller comprising a plurality of modules each capable of receiving host commands, a method of conflict detection, comprising:
receiving, at a first module, a first access request;
receiving, at a second module, a second access request;
at each of said first and second modules,
determining whether said received access request requires coordination;
if said received access request is determined to require coordination, executing a coordination request, and
if said coordination request is not granted,
indicating in a conflict table that said received access request is in conflict; and
holding said access request;
if said coordination request is granted,
executing said received access request;
searching said conflict table to find an entry in conflict with said received access request;
if said search is successful, notifying the module associated with said found entry; and
if said search is unsuccessful, releasing said coordination request.

18. The method of claim 17, wherein said step of executing a coordination request comprises:
searching a coordination data structure to find a data structure having an address range encompassing an address range associated said received access request;
if the data structure is found, attempting to reserve said data structure;
if said attempt to reserve is not successful,
indicating the said coordination request is not granted;
if said attempt to reserve is successful,
indicating that said coordination request is granted;
if said data structure is not found,
allocating said data structure and indicating said coordination request is granted.
